(19) United States
(12) Patent Application Publication
(10) Pub. No.: US 2026/0307733 A1
(43) Pub. Date: Oct. 8, 2026

(54) COWL CROSS BAR OF A VEHICLE AND A METHOD FOR MANUFACTURING THE SAME

(71) Applicants: HYUNDAI MOTOR COMPANY, Seoul (KR); KIA CORPORATION, Seoul (KR); HYUNDAI MOBIS CO., LTD., Seoul (KR)

(72) Inventors: Jae Hyun An, Hwaseong-si (KR); Min Ha Lee, Hwaseong-si (KR); Ik Keun Choi, Yongin-si (KR); Young Jin You, Yongin-si (KR)

(73) Assignees: HYUNDAI MOTOR COMPANY, Seoul (KR); KIA CORPORATION, Seoul (KR); HYUNDAI MOBIS CO., LTD., Seoul (KR)

(21) Appl. No.: 19/310,472

(22) Filed: Aug. 26, 2025

(30) Foreign Application Priority Data
Apr. 8, 2025 (KR) 10-2025-0045680

(51) Int. Cl. B62D 25/08; B29C 45/14

(52) U.S. Cl. CPC B62D 25/081; B29C 45/1418; B29C 45/14819; B29C 2045/14237

(57) ABSTRACT

A cowl crossbar of a vehicle includes: a main pipe bracket made of steel, extending in a width direction of the vehicle, and having an S-shaped cross-section when cut in a longitudinal direction of the vehicle; side mounting brackets joined to opposite end portions of the main pipe bracket; and a plastic sub-bracket, which may be insert-injection-molded so as to enclose the main pipe bracket and the side mounting brackets.

### CROSS-REFERENCE TO RELATED APPLICATION(S)

This application is based on and claims priority under 35 U.S.C. 119 to Korean Patent Application No. 10-2025-0045680, filed on Apr. 8, 2025, in the Korean Intellectual Property Office, the disclosure of which is herein incorporated by reference in its entirety.

### BACKGROUND

### 1. Field of the Disclosure

The present disclosure relates to a cowl crossbar of a vehicle and a method for manufacturing the same.

### 2. Description of the Prior Art

A cowl crossbar is one of the internal structural components of a vehicle, and is mainly located behind the dashboard to reinforce the vehicle body, provide a platform to which various components (such as an airbag module, an HVAC system, and a steering wheel) can be mounted, and reduce noise, vibration, and harshness (NVH) transmitted into the interior of the vehicle.

The foregoing described as the background art is intended merely to aid in understanding the background of the present disclosure. The foregoing is not intended to mean that the present disclosure falls within the purview of the related art already known to those of ordinary skill in the art.

### SUMMARY

Depending on the type of vehicle, the cowl crossbar used may vary depending on, for example, the width of the vehicle.

The present disclosure provides a cowl crossbar of a vehicle in which, even when the types of vehicles differ, the core components of the cowl crossbar are capable of being commonly used. This reduces cost and reduces the weight of the cowl crossbar while ensuring higher rigidity than conventional cowl crossbars or at least maintaining the same level of rigidity.

The technical aspects pursued in the present disclosure may not be limited to the above-mentioned technical aspects. Other technical aspects, which are not mentioned herein, may be more clearly understood from the following description by those of ordinary skill in the art to which the present disclosure pertains.

In view of the foregoing, a cowl crossbar of a vehicle according to the present disclosure includes a main pipe bracket made of steel, configured to extend in a width direction of the vehicle, and having an S-shaped cross-section when cut in a longitudinal direction of the vehicle. The cowl crossbar also includes side mounting brackets joined to opposite end portions of the main pipe bracket and includes a plastic sub-bracket insert-injection-molded so as to enclose the main pipe bracket and the side mounting brackets.

The cowl crossbar may further include a center support bracket joined to a point or portion of the main pipe bracket. The sub-bracket may be insert-injection-molded so as to enclose the main pipe bracket, the side mounting brackets, and the center support bracket.

The side mounting brackets and the center support bracket may be made of steel and may be joined to the main pipe bracket by welding.

The sub-bracket may be injection-molded to include a plurality of horizontal ribs and vertical ribs.

Each of the side mounting brackets may have an S-shaped cross-section when cut in the longitudinal direction of the vehicle and may be joined to the main pipe bracket by welding at a portion in contact with the main pipe bracket.

At a point, i.e., position or location of the sub-bracket, a column mounting bracket may be joined so as to partially enclose the point. The column mounting bracket may include an upper bracket and a lower bracket. The upper bracket and the lower bracket may form a closed cross-section with a square shape.

The upper bracket of the column mounting bracket may include a recessed portion recessed inward and a protruding portion protruding outward.

The lower bracket of the column mounting bracket may include a bent portion formed by bending at an end portion of an extension that extends in the longitudinal direction of the vehicle and may include a bead formed between the extension and the bent portion.

The main pipe bracket may include a bead in the shape of a small groove recessed inward and extending along a vertical direction of the main pipe bracket.

A method of manufacturing a cowl crossbar of a vehicle according to the present disclosure includes a joining step of joining side mounting brackets to opposite end portions of a main pipe bracket that is made of steel, that extends in a width direction of the vehicle, and that has an S-shaped cross-section when cut in a longitudinal direction of the vehicle. The method also includes an injection-molding step of insert-injection-molding a plastic sub-bracket so as to enclose the main pipe bracket and the side mounting brackets.

In the joining step, a center support bracket may be further joined to a point or part of the main pipe bracket. In the injection-molding step, the sub-bracket may be insert-injection-molded so as to enclose the main pipe bracket, the side mounting brackets, and the center support bracket.

The side mounting brackets and the center support bracket may be made of steel and may be joined to the main pipe bracket by welding.

In the injection-molding step, the sub-bracket may be injection-molded to include a plurality of horizontal ribs and vertical ribs.

After the injection-molding step, the method may further include an assembling step of joining a column mounting bracket so as to partially enclose a point or part of the sub-bracket.

According to the cowl crossbar and the method of manufacturing the same disclosed herein, the overall weight of the cowl crossbar may be reduced, and core components used in the manufacturing of the cowl crossbar may be standardized regardless of the type of vehicle. The manufacturing cost of the cowl crossbar may thereby be reduced.

Advantageous effects obtainable from the present disclosure may not be limited to the above-mentioned effects. Other effects, which are not mentioned herein, may be more clearly understood from the following description by those of ordinary skill in the art to which the present disclosure pertains.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 illustrates a cowl crossbar of a vehicle according to an embodiment of the present disclosure;

FIG. 2 illustrates core components constituting the cowl crossbar of FIG. 1;

FIG. 3 is a view illustrating a cross-section taken along line A-A of the cowl crossbar of FIG. 2;

FIG. 4 is a view illustrating a cross-section taken along line B-B of the cowl crossbar of FIG. 1;

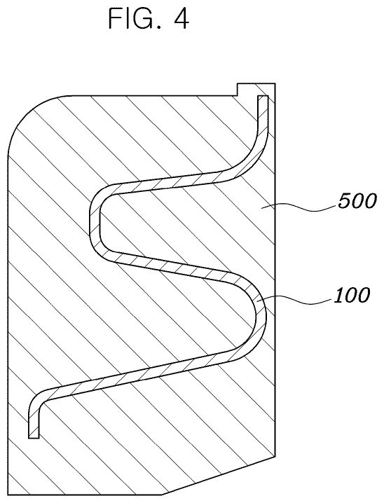

FIG. 5 is a view illustrating a joined portion between a main pipe bracket and a side mounting bracket of a cowl crossbar according to an embodiment of the present disclosure;

FIG. 6 is a view illustrating a column mounting bracket of a cowl crossbar according to an embodiment of the present disclosure;

FIG. 7 is a widthwise cross-sectional view of a main pipe bracket with vertical ribs formed on the main pipe bracket by plastic resin flowing thereon;

FIG. 8 is a longitudinal cross-sectional view of a main pipe bracket illustrating beads formed on the main pipe bracket to enhance the fixing force of the vertical ribs; and

FIG. 9 is a flowchart illustrating a method of manufacturing a cowl crossbar of a vehicle according to the present disclosure.

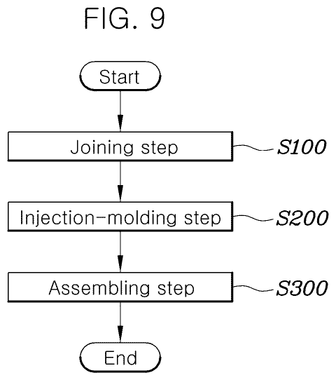

### DETAILED DESCRIPTION OF EMBODIMENTS

In describing the embodiments set forth herein, a detailed description of known functions or configurations incorporated herein has been omitted where it has been determined that the description may have made the subject matter of the embodiments set forth herein unclear. In addition, it should be appreciated that the accompanying drawings are provided only to aid in understanding the embodiments set forth herein. The technical concepts and embodiments of the present disclosure are not limited to the accompanying drawings and include all modifications, equivalents, or alternatives falling within the spirit and scope of the present disclosure. The following descriptions are not intended to limit the present disclosure to the described form or specific field. It should be understood that various alternative modifications and changes may be made to the present disclosure regardless of whether the descriptions are explicit or implicit. Those having ordinary skill in the art to which the present disclosure pertains should appreciate that the contents of the present disclosure may be changed in forms and details.

The technical concepts of the present disclosure are described with reference to specific embodiments. However, as understood by a person of ordinary skill in the art to which the present disclosure belongs, the various aspects disclosed herein may be modified or otherwise implemented in different ways without departing from the spirit and scope of the present disclosure. Accordingly, the following description is to be considered as describing examples, and is intended to teach those of ordinary skill in the art to which the disclosure belongs how to make and use various embodiments. It is to be understood that the forms of the disclosure illustrated and described herein are example embodiments. Equivalent elements, materials, processes, or steps may be substituted for those exemplified and described in the present disclosure. Expressions used in the present disclosure, such as “including,” “comprising,” “incorporating,” “consisting of,” “having,” or “is,” and variations thereof, should be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as examples and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method disclosed herein. Accordingly, references to joining should be interpreted broadly. Moreover, these references to joining do not imply that two or more elements are directly connected to each other. In addition, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. In other words, these terms may be used to describe various components but should not be construed as limiting the components to those terms. These terms are used only to distinguish one component from another.

The terms “module” and “unit” used for the elements in the following description are given or interchangeably used in consideration of only the ease of writing the specification, and do not have distinct meanings or roles by themselves. When a component, device, unit, module, element, apparatus, or the like of the present disclosure is described as having a purpose or performing an operation, function, or the like, the component, device, unit, module, element, or apparatus should be considered herein as being “configured to” meet that purpose or to perform that operation or function.

In the case where an element is referred to as being “connected” or “coupled” to any other elements, it should be understood that, not only the element may be directly connected or coupled to the other elements, but also another element may exist therebetween. Contrarily, in the case where an element is referred to as being “directly connected” or “directly coupled” to any other element, it should be understood that no other element exists therebetween.

Any number or variety of components in any of the configurations described herein may be included within the scope of the present disclosure. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein are described in detail with reference to the accompanying drawings. The same or similar elements are given the same and similar reference numerals throughout the description and drawings, so duplicate descriptions thereof have been omitted.

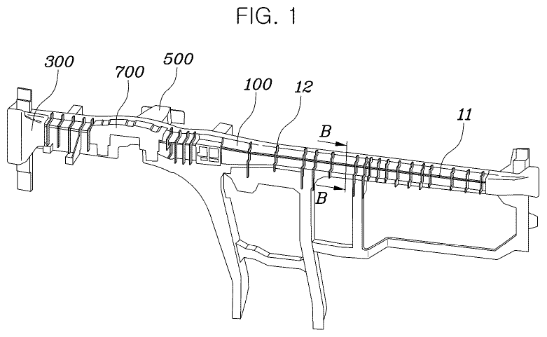

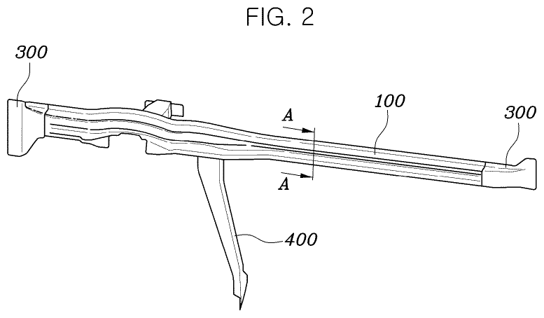

FIG. 1 illustrates a cowl crossbar of a vehicle according to an embodiment of the present disclosure. FIG. 2 illustrates core components constituting the cowl crossbar of the vehicle. Referring to FIGS. 1 and 2, the cowl crossbar of the vehicle according to the present disclosure is configured as follows.

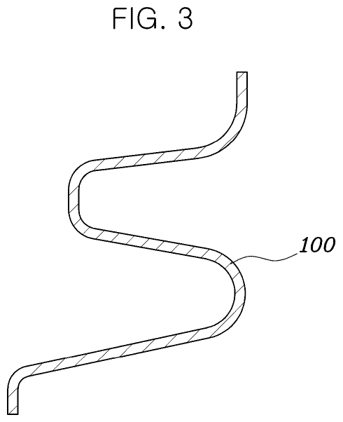

First, a main pipe bracket 100, which is made of steel, is prepared. The main pipe bracket 100 extends or is configured to extend in the width direction of the vehicle and has an S-shaped cross-section when cut or viewed in the longitudinal direction of the vehicle. The main pipe bracket 100 may extend in the width direction of the vehicle to ensure rigidity in the width direction of the vehicle. In addition, as illustrated in FIG. 3, the main pipe bracket 100 includes an S-shaped cross-section. As is described below, since the main pipe bracket 100 has an S-shaped cross-section and plastic resin forming a sub-bracket 500 fills the hollow space of the S-shaped cross-section, the front portion and the rear portion of the main pipe bracket 100 are reinforced. Thus, rigidity in the longitudinal direction of the vehicle can also be ensured.

As described above, the main pipe bracket 100 may be made of steel and corresponds to a core component that ensures the rigidity of the cowl crossbar. The main pipe bracket 100 may be manufactured by extrusion so as to have the S-shaped cross-section.

Side mounting brackets 300 are coupled to opposite end portions of the main pipe bracket 100. The side mounting brackets 300 are located at the opposite end portions of the main pipe bracket 100. When the manufacturing of the cowl crossbar is completed, the cowl crossbar may be fixed to the vehicle body via the side mounting brackets 300.

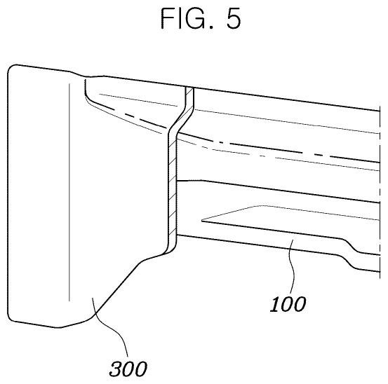

The side mounting brackets 300 may be made of the same steel material as the main pipe bracket 100. Referring to FIG. 5, the side mounting brackets 300 also have an S-shaped cross-section when cut in the longitudinal direction of the vehicle and may be joined to the main pipe bracket 100 by welding at the portions in contact with the main pipe bracket 100.

By separately manufacturing the side mounting brackets 300 and joining them to the main pipe bracket 100 in this way, the main pipe bracket 100 may be commonly used. In other words, the specifications, such as the vehicle width, may vary depending on the type of vehicle. Thus, while the side mounting brackets 300 for mounting the cowl crossbar to the vehicle body are manufactured differently for each vehicle type, the main pipe bracket 100, which is a core component that provides rigidity to the cowl crossbar, is made to be commonly used. As a result, it is possible to reduce the manufacturing cost of the cowl crossbar.

In addition, by unifying the main pipe bracket 100 and manufacturing the side mounting brackets 300 separately, the S-shaped cross-sectional structure of the main pipe bracket 100 may be made as long as possible. This may enable an increase in rigidity and an improvement in moldability and productivity of the main pipe bracket 100.

After the side mounting brackets 300 are joined to the main pipe bracket 100, a plastic sub-bracket 500 may be insert-injection-molded so as to enclose the main pipe bracket 100 and the side mounting brackets 300. In other words, the assembly of the main pipe bracket 100 and the side mounting brackets 300 may be inserted into a mold, and plastic resin may be injected to mold the remaining sub-bracket 500. Since the main pipe bracket 100 has an S-shaped cross-section, as illustrated in FIG. 3, the contact area between the injected plastic resin and the main pipe bracket 100 is maximized. This increases the physical bonding force between the sub-bracket 500 and the main pipe bracket 100. In addition, the insert-injection-molding method that encloses the main pipe bracket 100 allows complete integration between the sub-bracket 500 and the main pipe bracket 100. This simplifies the assembly process and extends the durability and service life of the components.

Accordingly, the main pipe bracket 100, the side mounting brackets 300, and the sub-bracket 500 may constitute the cowl crossbar of the vehicle so as to contribute to an increase in the rigidity of the vehicle.

The sub-bracket 500 may also be injection-molded to include a plurality of horizontal ribs 11 and a plurality of vertical ribs 12. In one example, one horizontal rib may be provided. The sub-bracket 500 is designed and molded to include the plurality of horizontal ribs 11 and vertical ribs 12 in order to enhance structural strength and improve resistance to external impacts. Such a sub-bracket 500 is manufactured through an insert-injection-molding process in a manner that encloses the main pipe bracket 100.

The plurality of horizontal ribs 11 formed on the sub-bracket 500 effectively distribute loads applied in the horizontal direction. The vertical ribs 12 support forces applied in the vertical direction. The various ribs improve overall rigidity and stability.

Meanwhile, a center support bracket 400 may be further joined to a point, i.e., location or position, of the main pipe bracket 100, the point or location being generally central to or somewhat between the two opposite ends of the cowl crossbar. The center support bracket 400 serves to provide additional support and connection functions in the central portion of the cowl crossbar and ensures stability of the vehicle's internal structure and proper arrangement of various components.

The center support bracket 400 reinforces the central portion of the cowl crossbar so as to assist in stably maintaining the overall shape of the cowl crossbar without bending or deformation. In addition, vibrations and loads generated during vehicle driving may be effectively dispersed.

Like the main pipe bracket 100 and the side mounting brackets 300, the center support bracket 400 may be made of steel and may be joined to the main pipe bracket 100 by welding. In addition, when the cowl crossbar is manufactured to additionally include the center support bracket 400, the sub-bracket 500 may be molded so as to enclose the center support bracket 400 as well.

At a point, i.e., part, location, or position, of the sub-bracket 500, a column mounting bracket 700 is joined so as to partially enclose the point or joint of the sub-bracket 500. The column mounting bracket 700 includes an upper bracket 710 and a lower bracket 730. The upper bracket 710 and the lower bracket 730 may form a closed cross-section with a square shape.

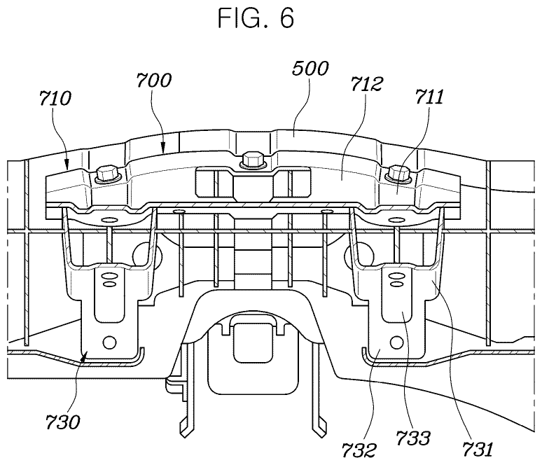

Referring to FIGS. 1 and 6, the column mounting bracket 700 is assembled to the cowl crossbar of the vehicle to provide a space in which a steering column of the vehicle is accommodated. The column mounting bracket 700 also includes a structure configured to suppress the transmission of noise and vibration in the vertical direction of the vehicle.

The column mounting bracket 700 is manufactured to include the upper bracket 710 and the lower bracket 730. The upper bracket 710 and the lower bracket 730 may be integrally formed and form a closed cross-section having a trapezoidal shape. This suppresses the transmission of noise and vibration in the vertical direction of the vehicle.

In addition, the upper bracket 710 includes a recessed portion 711 recessed inward and a protruding portion 712 protruding outward. By providing bends in the shape of the upper bracket 710 through the recessed portion 711 and the protruding portion 712, the section modulus may be increased. This suppresses the transmission of noise and vibration to the driver.

The lower bracket 730 includes a bent portion 732 formed by bending at an end portion of an extension 731 that extends in the longitudinal direction of the vehicle. A bead 733 may be formed between the extension 731 and the bent portion 732 to reinforce the rigidity of the column mounting bracket 700 itself.

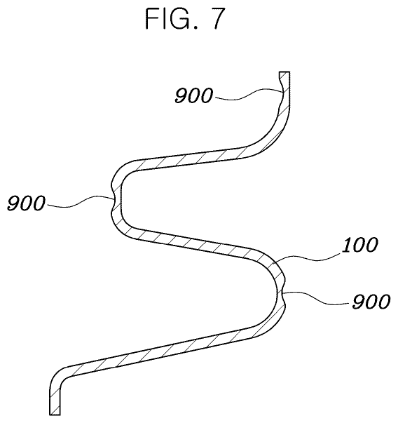

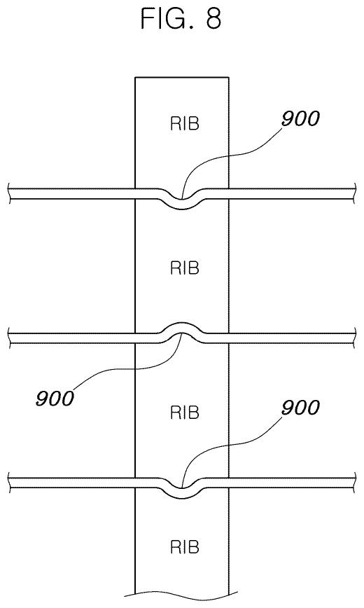

Referring to FIGS. 7 and 8, beads 900 in the shape of a small groove recessed inward are formed in the main pipe bracket 100. The beads 900 may be formed along the vertical direction of the main pipe bracket 100. When plastic resin is injected into the main pipe bracket 100, as illustrated in FIG. 7, the plastic resin flows along the surface of the main pipe bracket, during which vertical ribs may be formed. In this case, the formed ribs penetrate into the beads of the metal and solidify. The ribs partially engage with the beads, so that the vertical ribs formed on the main pipe bracket are firmly fixed thereto. This ensures that excellent bonding strength is achieved even without additional fixing means such as adhesive or bolts.

A method of manufacturing a cowl crossbar of a vehicle according to the present disclosure is also provided. The method includes a joining step (S100) of joining side mounting brackets to opposite end portions of a main pipe bracket that is made of steel, that extends in the width direction of the vehicle, and that has an S-shaped cross-section when cut or viewed in the longitudinal direction of the vehicle. The method may also include an injection-molding step (S200) of insert-injection-molding a plastic sub-bracket so as to enclose the main pipe bracket and the side mounting brackets.

In the joining step (S100), a center support bracket may be further joined to a point, i.e., a location or position, of the main pipe bracket. In the injection-molding step (S200), the sub-bracket may be insert-injection-molded so as to enclose the main pipe bracket, the side mounting brackets, and the center support bracket.

The side mounting brackets and the center support bracket are made of steel and may be joined to the main pipe bracket by welding.

In the injection-molding step (S200), the sub-bracket may be injection-molded to include a plurality of horizontal ribs and vertical ribs.

After the injection-molding step (S200), the method may further include an assembling step (S300) of joining a column mounting bracket so as to enclose a point or part of the sub-bracket.

Although technical concepts of the present disclosure have been described and illustrated in conjunction with particular embodiments thereof, it should be apparent to those of ordinary skill in the art that various improvements and modifications may be made to the present disclosure without departing from the technical concepts of the present disclosure defined by the appended claims.

What is claimed is:

1. A cowl crossbar of a vehicle, the cowl crossbar comprising:
a main pipe bracket made of steel, configured to extend in a width direction of the vehicle, and having an S-shaped cross-section in a longitudinal direction of the vehicle;
side mounting brackets joined to opposite end portions of the main pipe bracket; and
a plastic sub-bracket enclosing the main pipe bracket and the side mounting brackets.

2. The cowl crossbar of claim 1, further comprising:
a center support bracket joined to the main pipe bracket,
wherein the sub-bracket encloses the main pipe bracket, the side mounting brackets, and the center support bracket.

3. The cowl crossbar of claim 2, wherein the side mounting brackets and the center support bracket are made of steel and are each welded to the main pipe bracket.

4. The cowl crossbar of claim 1, wherein the sub-bracket includes a plurality of vertical ribs and one or more horizontal ribs.

5. The cowl crossbar of claim 1, wherein each of the side mounting brackets has an S-shaped cross-section in the longitudinal direction of the vehicle and is welded to the main pipe bracket at a portion in contact with the main pipe bracket.

6. The cowl crossbar of claim 1, further comprising:
a column mounting bracket joined to the sub-bracket at a joint so as to partially enclose the joint,
wherein the column mounting bracket includes an upper bracket and a lower bracket that form a closed cross-section with a square shape.

7. The cowl crossbar of claim 6, wherein the upper bracket of the column mounting bracket comprises a recessed portion recessed inward and a protruding portion protruding outward.

8. The cowl crossbar of claim 6, wherein:
the lower bracket of the column mounting bracket comprises a bent portion that is bent at an end portion of an extension that extends in the longitudinal direction of the vehicle; and
a bead disposed between the extension and the bent portion.

9. The cowl crossbar of claim 1, wherein the main pipe bracket comprises a bead in a shape of a small groove recessed inward and extending along a vertical direction of the main pipe bracket.

10. A method of manufacturing a cowl crossbar of a vehicle, the method comprising:
joining side mounting brackets to opposite end portions of a main pipe bracket that is made of steel, that is configured to extend in a width direction of the vehicle, and that has an S-shaped cross-section in a longitudinal direction of the vehicle; and
insert-injection-molding a plastic sub-bracket to enclose the main pipe bracket and the side mounting brackets.

11. The method of claim 10, further comprising:
joining a center support bracket to the main pipe bracket; and
insert-injection-molding the sub-bracket to enclose the main pipe bracket, the side mounting brackets, and the center support bracket.

12. The method of claim 11, wherein:
the side mounting brackets and the center support bracket are made of steel; and
the side mounting brackets and the center support bracket are joined to the main pipe bracket by welding.

13. The method of claim 10, wherein the sub-bracket is injection-molded to comprise a plurality of vertical ribs and one or more horizontal ribs.

14. The method of claim 10, further comprising:
joining a column mounting bracket so as to partially enclose a part of the sub-bracket after the insert-injection-molding.
